(19) United States
(12) Patent Application Publication
(10) Pub. No.: US 2020/0370726 A1
(43) Pub. Date: Nov. 26, 2020

(54) Projection Device for a Motor Vehicle Headlight

(71) Applicant: ZKW Group GmbH, Wieselburg (AT)

(72) Inventors: Bernhard MANDL, Ober-Grafendorf (AT); Andreas MOSER, Perg (AT); Friedrich BAUER, Bergland (AT); Peter SCHADENHOFER, Roggendorf (AT)

(21) Appl. No.: 16/769,696

(22) PCT Filed: Nov. 27, 2018
(86) PCT No.: PCT/EP2018/082657

§ 371 Date: Jun. 4, 2020

(30) Foreign Application Priority Data
Dec. 5, 2017 (EP) 17205400.9

(51) Int. Cl. F21S 41/43; F21S 41/265; F21S 41/143

(52) U.S. Cl. CPC F21S 41/43; F21Y 2115/10; F21S 41/143; F21S 41/265

(57) ABSTRACT

The invention relates to a projection device (1) for a motor vehicle headlight, wherein the projection device (1) is designed to project light of at least one light source (2) associated with the projection device (1) into a zone in front of the motor vehicle in at least one light distribution pattern, a total number of the low-beam microlenses comprising at least two groups of low-beam microlenses.

The invention relates to a projection device for a motor-vehicle headlamp, wherein the projection device is set up for imaging light of at least one light source assigned to the projection device in a region in front of a motor vehicle in the form of at least one light distribution, namely a dipped-beam distribution, wherein the projection device comprises:
an entrance optical element, which has a total number of micro-entrance optical elements (3a), which are preferably arranged in an array,
an exit optical element, which has a total number of micro-exit optical elements (4a), which are preferably arranged in an array, wherein
   precisely one micro-exit optical element is assigned to each micro-entrance optical element,
   wherein the micro-entrance optical elements are constructed in such a manner and/or the micro-entrance optical elements and the micro-exit optical elements are arranged in such a manner with respect to one another, that essentially the total light exiting from a micro-entrance optical element only enters into the assigned micro-exit optical element, and wherein the light pre-shaped by the micro-entrance optical elements is imaged by the micro-exit optical elements into a region in front of the motor vehicle as at least one light distribution,
   wherein each micro-entrance optical element focuses the light passing through it into at least one micro-entrance-optical-element focal point, wherein the micro-entrance-optical-element focal point lies between the micro-entrance optical element and the assigned micro-exit optical element, wherein at least one screen device is arranged between the micro-entrance optical element and the micro-exit optical element,
   wherein, in each case, a dipped-beam micro-optical element is constructed at least by the micro-entrance optical element, the assigned micro-exit optical element and also the at least one screen device lying therebetween,
   wherein the at least one screen device is set up for limiting the light distribution imaged by the respective micro-exit optical element in such a manner that the light distribution radiated by the micro-exit optical element forms a portion of the dipped-beam distribution, wherein, for this, the screen device has at least one optically effective screen edge imaging the course of a cut-off line of the dipped-beam distribution.

The invention furthermore relates to a microprojection light module for a motor vehicle headlamp, comprising at least one projection device according to the invention and at least one light source for feeding light into the projection device.

Furthermore, the invention relates to a vehicle headlamp, particularly a motor-vehicle headlamp, comprising at least one microprojection light module according to the invention.

From the prior art, e.g. the document AT 514967 B1 has become known, which shows a projection device of the type mentioned at the beginning. A projection device is shown therein, which has a number of micro-entrance optical elements and micro-exit optical elements, wherein screen devices are arranged between the micro-entrance and exit optical elements. So as to not exceed legally required maximum values of the light intensity inside a light distribution, there is a requirement to design the local intensity to be correspondingly low. In the case of macroprojection modules, shading elements were provided for this purpose e.g. in the projection lens, so that illuminance is lower at these points. Previous measures for darkening individual regions of the light distribution comprise a manipulation of the projection lens or the illumination device by means of a shading element. The disadvantage thereof is that this shading element strongly darkens the region to be shaded and it was not possible to realize a consistently uniform brightness transition to non-darkened regions using such a shading element. The shaded region in the light image was hitherto clearly recognizable with the naked eye as a local minimum of the intensity of the light distribution and therefore had a disadvantageous effect on the overall impression of the light distribution.

It is an object of the invention to overcome the above-mentioned disadvantages of the prior art. This object is achieved using a projection device of the type mentioned at the beginning, in which, according to the invention, the total number of dipped-beam micro-optical elements comprises at least two groups of dipped-beam micro-optical elements, namely
a first group of dipped-beam micro-optical elements having at least one first variant of screen devices, and
a second group of dipped-beam micro-optical elements having at least one second variant of screen devices, wherein the configuration of the second variant of screen devices deviates from the configuration of the first variant of screen devices at least in that the second variant of screen devices has
shading elements (50L) protruding along a section of the course of the screen edge, and/or
shading elements (Segm10) spaced from the screen edge, which are completely enclosed by a light-permeable region of the screen device.

By providing at least two variants of screen devices, it is possible advantageously to influence the dipped-beam distribution by means of a corresponding choice of the number and/or configuration of the screen devices or any shading elements provided therein, in that legal requirements with regards to darkened regions in the light distribution can be fulfilled precisely on the one hand and a uniform transition in the light distribution can be created at the same time.

An optically effective screen edge is understood to mean a screen edge which intervenes in the imaging of the light distribution to limit the same.

The formulation “essentially the total light exiting” means in this case that an attempt is made to irradiate at least the majority of the entire luminous flux, which exits from a micro-entrance optical element, solely into the assigned micro-exit optical element. In particular, one should strive not to irradiate luminous flux into the adjacent micro-exit optical elements, such that as a result, no disadvantageous optical effects result, such as scattered light, which may lead to dazzlement, etc.

In addition, the formulation “wherein the micro-entrance optical elements are constructed in such a manner and/or the micro-entrance optical elements and the micro-exit optical elements are arranged in such a manner with respect to one another” is also to be understood to mean that additional measures, such as for example screens (see below) may be provided, which either exclusively or preferably additionally to their actual function, also have the function that the total luminous flux is directed precisely onto the assigned micro-exit optical element.

Due to the use of a number, plurality or multiplicity of assigned micro-optical elements instead of a single optical element, as in conventional projection systems, both the focal lengths and the dimensions of the micro-optical elements are inherently considerably smaller than in the case of a “conventional” optical element. Likewise, the central thickness can be reduced compared to a conventional optical element. As a result, the construction depth of the projection device may be reduced considerably compared to a conventional optical element.

By increasing the number of micro-optical-element systems, on the one hand, the luminous flux may be increased or scaled, wherein an upper limit with regards to the number of micro-optical-element systems is first limited by the respectively available production methods. For generating a dipped-beam function, e.g. 200 to 400 micro-optical-element systems are sufficient or beneficial, wherein this should neither describe a limiting upper or lower value, but rather merely an exemplary number. To increase the luminous flux, it is beneficial to increase the number of very similar micro-optical elements. Conversely, one may use the multiplicity of micro-optical elements in order to introduce micro-optical elements of different optical behaviour into a projection system, in order to generate or superimpose different light distributions. The multiplicity of micro-optical elements therefore also allows design possibilities, which are not present in a conventional optical element.

One such light module is additionally scalable, i.e. a plurality of structurally identical or similarly built light modules can be assembled to form a larger overall system, e.g. to form a vehicle headlamp.

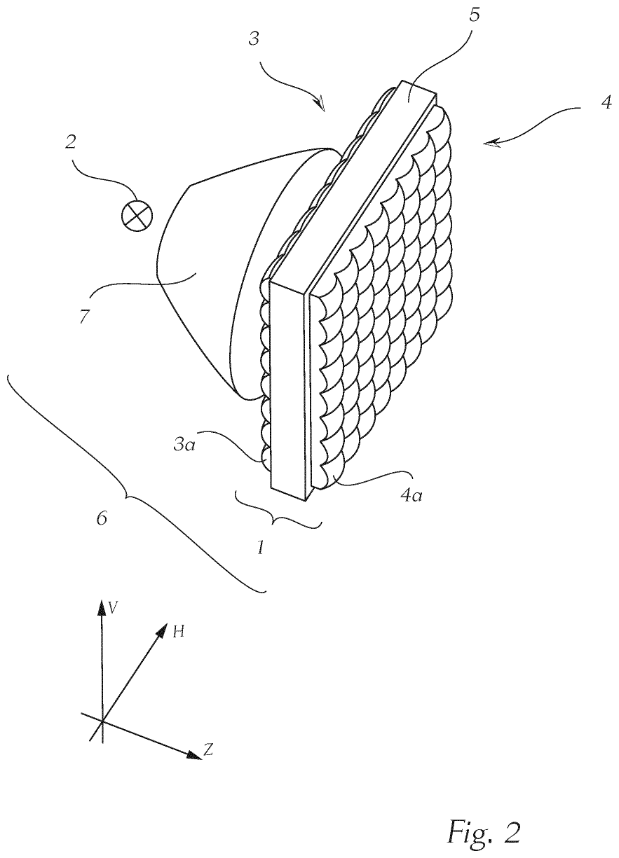

In a conventional projection system with a projection lens, the lens has a typical diameter of between 60 mm and 90 mm. In a module according to the invention, the individual micro-optical-element systems have typical dimensions of approx. 2 mm×2 mm (in V and H) and a depth (in Z, cf. e.g. FIG. 2) of approx. 6 mm-10 mm, so that in the Z direction, a considerably smaller depth of a module according to the invention results compared to conventional modules.

The light module according to the invention or the projection device may have a small construction depth and are fundamentally freely formable, i.e. it is e.g. possible to configure a first light module for generating a first partial light distribution separately from a second light module for a second partial light distribution and to arrange the same relatively freely, i.e. vertically and/or horizontally and/or offset with respect to one another in terms of depth, so that design specifications can also be realized more easily.

A further advantage of a light module according to the invention or a projection device is that the exact positioning of the light source(s) in relation to the projection device is dispensed with. Exact positioning is less critical insofar as the distance of the illumination unit from the microlens array does not have to be exact. Since the micro-entrance and micro-exit optical elements are already optimally adapted to one another, however, as these virtually form a system, an inexact positioning of the real light source(s) carries less weight. The real light sources are for example approximately punctiform light sources, such as e.g. light-emitting diodes, the light of which is directed in a parallel manner by collimators, such as compound parabolic concentrators (CPCs) or TIR (Total Internal Reflection) lenses.

The projection device or the light module may likewise contain additional micro-optical-element systems, with the aid of which different types of light distributions than a dipped-beam distribution is generated. In this case, “a certain type” of the light distribution is understood to mean a light distribution generated according to relevant standards, for example a light distribution according to standards of UN/ECE regulations in the states of the European Union, particularly regulations 123 and 48 or relevant standards in the other countries or regions.

In the following, the term “carriageway” is only used for simplified representation, as whether the light image is actually on the carriageway or also extends beyond that of course depends on the local conditions. For example, in order to test the radiated light distributions, one generates a projection of the light image onto a vertical surface in accordance with the relevant standards, for example in accordance with the regulation numbers 123 and 48 of the United Nations Economic Commission for Europe (UN/ECE) “Uniform provisions concerning the approval of adaptive front-lighting systems (AFS) for motor vehicles” and “Uniform provisions concerning the approval of vehicles with regard to the installation of lighting and light-signalling devices”, the Federal Motor Vehicle Safety Standard FMVSS No. 108 valid for the United States of America, “Lamps, reflective devices, and associated equipment”, which is specified in the Code of Federal Regulations CFR under the title 49: Transportation in Chapter V, Part 571—Federal Motor Vehicle Standards in Subpart B as § 571.108, and the National Standard of the People's Republic of China GB/T 30036/2013 “Adaptive Front-Lighting System for Motor Vehicles”, which relate to motor vehicle lighting technology.

Generally, it is also possible that the first group has shading elements. The independent claim of the present invention does not say that the first group has to be free of shading elements, but rather that the second group has at least one second variant of screen device, which differs from the first variant, for example in that a different type of shading elements is provided. Of course, the first group may however likewise be free of shading elements.

In particular, it may be beneficial if, in the case of such an illumination device, two or more groups are provided for generating different light distributions, wherein each group forms a different light distribution, which is for example chosen from the following light distributions:
cornering light distribution;
town light distribution;
country light distribution;
motorway light distribution;
light distribution for booster light for motorway light;
cornering-beam light distribution;
near field dipped-beam light distribution;
light distribution for asymmetric far field dipped beam;
light distribution for asymmetric far field dipped beam in cornering-beam mode;
main-beam light distribution;
anti-glare main-beam light distribution.

Examples of such light distributions can be drawn inter alia from the document AT 514967 B1.

Preferably, it may be provided that each dipped-beam micro-optical element, which has a screen device of the second variant, has exactly one shading element protruding along a section of the course of the screen edge. The shading element preferably extends in the vertical direction in this case, in order to shade the point “SOL” of the light distribution. Of course, further shading elements may also be provided, which do not protrude from the screen edge. A corresponding darkening of the SOL point may for example be created by means of the choice of a suitable number and dimensioning of dipped-beam micro-optical elements with shading elements according to the second variant. The expression “protruding from the screen edge” is understood in this case to mean that the screen edge can in any case still be discerned as a screen edge for a dipped-beam distribution as such. The longitudinal extent of the screen edge, which is composed of straight-line screen edge sections, which are horizontal or obliquely inclined, is therefore interrupted by the protruding shading element. In other words, the screen edge is no longer discernible in the region of a fully non-light-permeable shading element, as the screen edge no longer becomes visible as an edge in this region owing to the presence of the protruding shading element. The screen edge continues again (in an optically visible manner) before and after the shading element.

It may advantageously be provided that each dipped-beam micro-optical element, which has a screen device of the second variant, has exactly one shading element spaced from the screen edge, which is completely enclosed by a light-permeable region of the screen device. These shading elements can be arranged in such a manner that they effect shading inside the segment of a dipped-beam distribution. A correspondingly homogeneous and uniform darkening inside the segment 10 may for example be created by means of the choice of a suitable number and dimensioning of dipped-beam micro-optical elements using these shading elements.

It may beneficially be provided that the at least one screen device is connected to a light-permeable support, which is coated on its surface with an at least partially non-light-permeable material to form a predeterminable light distribution. The at least partially non-light-permeable layer can be applied e.g. by means of a lithographic method. Also, under certain circumstances, a further screen device could be provided on the other side of the support, e.g. to prevent scattered light.

For particularly efficient and exact specification of the transition between a darkened region and a non-darkened region, it may be provided that at least individual shading elements of the screen device of the second variant are partially light-permeable. Also, the light permeability of individual shading elements may vary.

Alternatively or additionally, it may likewise be provided that at least individual shading elements of the screen device of the second variant are completely non-light-permeable. The configuration of the overall shading can be varied by means of a suitable selection of the number and the configuration of the shading elements.

In addition, it may be provided that individual shading elements of the screen device of the second variant are provided for limiting the luminosity of the light distribution in a 50L measuring point. The 50L measuring point for example lies at an angle 3.43° to the left (L) and 0.86° downwards (D). In the specification FMVSS, a measuring point, without specific label, is at 0.86 D and 3.5 L.

Preferably, it may be provided that the individual shading elements are arranged in such a manner that they shade a region of the light distribution radiated by the respective dipped-beam micro-optical element, wherein the region comprises a horizontal angle of at most 5° and a vertical angle of at most 5°. The shaded region could comprise a horizontal and vertical angle of (1° or 2°) to 5° and could for example be constructed in a circular manner.

In addition, it may be provided that the size of at least one shading element of a screen device of the second variant deviates from the size of at least one shading element of a further screen device of the second variant. In this case, the expression “size” is understood to mean the area over which the respective shading element extends. In this case, either the shape can be scaled or alternatively it is also possible that the shapes of the shading elements deviate from one another, i.e. constitute different geometric figures.

In addition, it may be provided that individual shading elements of the screen device of the second variant are provided for limiting the luminosity of the light distribution in segment 10 of the dipped-beam distribution. The expression “segment 10” is understood to mean a line at height −4° (−4D) between 4.5° L and 2° R.

Preferably, it may be provided that individual shading elements are arranged in such a manner that they shade a region of the light distribution radiated by the respective dipped-beam micro-optical element, wherein the region comprises a horizontal angle of at most 10° and a vertical angle of at most 3°. Therefore, the width may for example be at most 10° and the height may for example be between 1° and 3°. This shading element may therefore be constructed as a suspended beam, wherein the dimensions of the individual shading elements may vary for generating a homogeneous transition. In this context, the production of these shading elements by means of lithographic processes is particularly advantageous.

In particular, it may be provided that the support of the at least one screen device consists of glass. In addition, it may be provided that the entrance optical element and also the exit optical element are securely connected to at least one support of the screen device arranged between the entrance optical element and the exit optical element. As a result, undesired influences—e.g. owing to thermal expansion—can be minimized, and a permanent and exact positioning of the entrance optical element in relation to the exit optical element or vice versa can be ensured. To this end, it may advantageously be provided that the secure connection of the entrance optical element and the exit optical element to the at least one support is formed as a transparent adhesively bonded connection.

Furthermore, it may be provided that the total number of dipped-beam micro-optical elements comprises a third group of dipped-beam micro-optical elements with screen devices of a third variant, in that, in the screen device of the third variant
at least one at least partially light-permeable window is formed, inside a light-shading region of the screen device constructed up to the screen edge, for forming a light distribution lying above the cut-off line. This region lying above the cut-off line is therefore illuminated so that traffic signs for example can be better discerned. This light function is often termed a “sign light”, wherein the intensity of the illumination in this region can be determined by the configuration of the light-permeable window and by the number of dipped-beam micro-optical elements of the third variant. Incidentally, a combination of the dipped-beam micro-optical elements of the third variant with those of the first or second variant is likewise possible.

Generally, all embodiments of the present invention may also be provided in connection with the generation of near-field light distributions.

Very generally, it may be provided that different dipped-beam micro-optical elements have (e.g. at least two) differently constructed screen devices or (e.g. at least two) shading elements of different sizes, wherein the photometric region shaded by the shading elements at least partially overlaps. This may apply to the shading elements of the first, the second and/or the third variant or group. In particular, it may be provided that the shaded photometric region of the smaller shading element is accommodated completely in the shaded photometric region of the next largest shading element or the shading elements may be constructed in such a manner that this effect occurs.

The invention furthermore relates to a microprojection light module for a motor vehicle headlamp, comprising at least one projection device according to the invention and at least one light source for feeding light into the projection device. Preferably, an LED light source is assigned to each dipped-beam micro-optical element.

Furthermore, the invention relates to a vehicle headlamp, particularly a motor-vehicle headlamp, comprising at least one microprojection light module according to the invention.

Additionally, the invention relates to a vehicle, a motor vehicle in particular, having at least one vehicle headlamp according to the invention.

The invention is explained in more detail in the following on the basis of exemplary and non-limiting embodiments, which are shown in the figures. In the figures

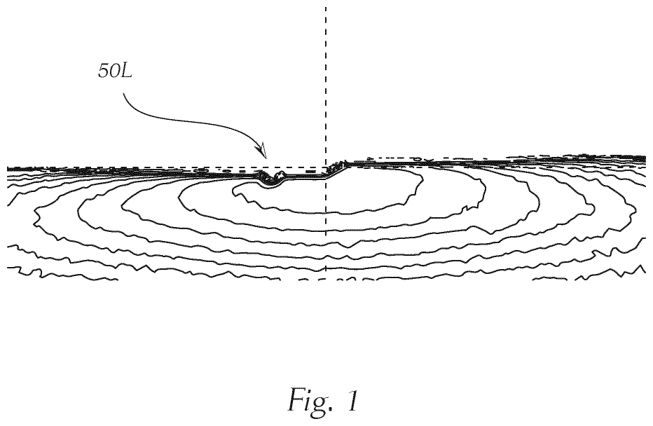

FIG. 1 shows an exemplary image of a dipped-beam distribution according to the prior art,

FIG. 2 shows a schematic illustration of an exemplary projection device,

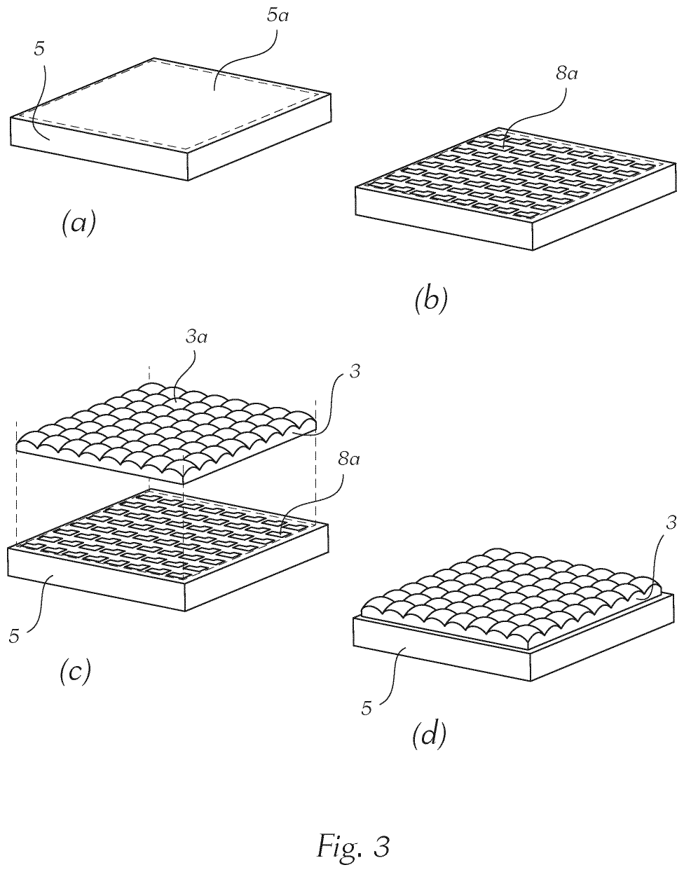

FIGS. 3a to d show a schematic illustration of a method for applying the screen device to a transparent support which can be connected to the micro-entrance optical element and micro-exit optical element,

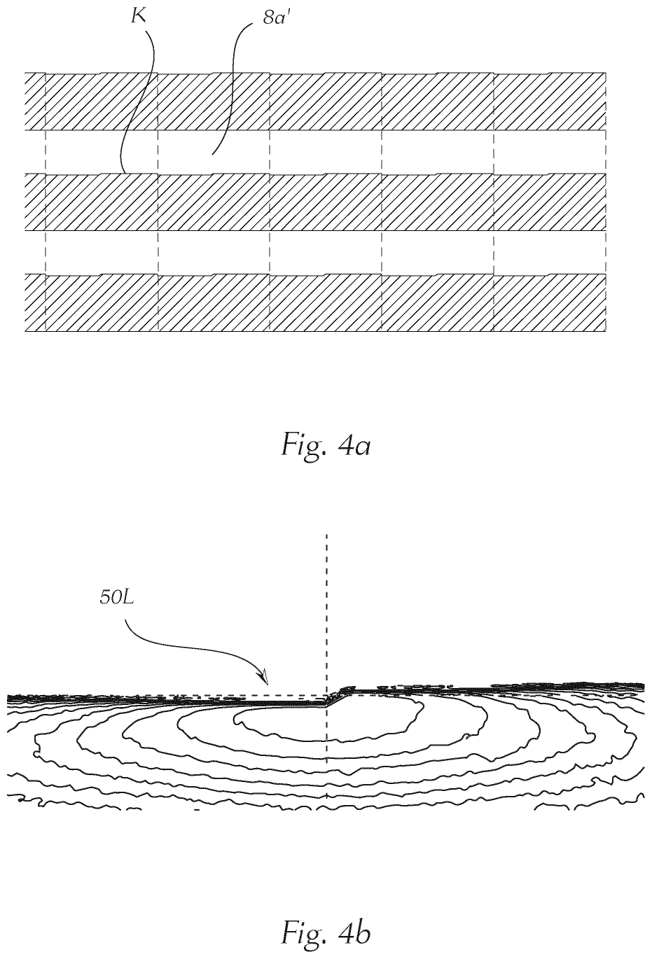

FIG. 4a shows an exemplary configuration of screen devices located next to one another according to the prior art,

FIG. 4b shows a light distribution generated by means of the device according to FIG. 4a,

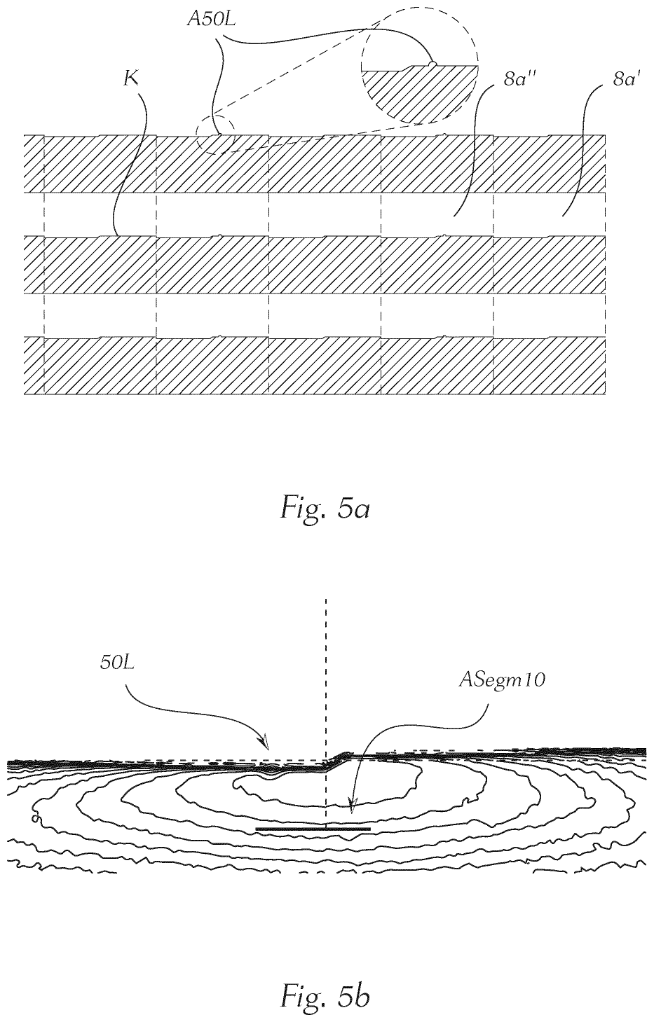

FIG. 5a shows a schematic illustration of a configuration according to the invention of screen devices lying next to one another, according to a first and a second variant,

FIG. 5b shows a light distribution generated by means of a projection device comprising the screen devices according to FIG. 5a,

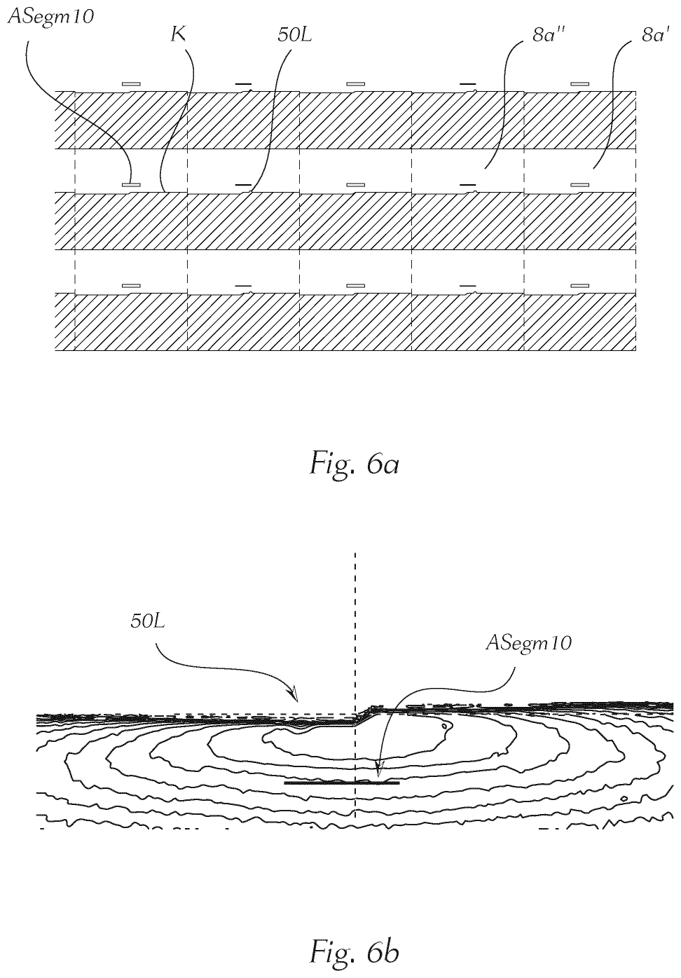

FIG. 6a shows a further and schematic illustration of a configuration according to the invention of screen devices lying next to one another, according to a first and a second variant, and

FIG. 6b shows a light distribution generated by means of a projection device comprising the screen devices according to FIG. 6a.

In the following figures—insofar as not otherwise specified—the same reference numbers label the same features.

FIG. 1 shows an exemplary image of a cutout of a dipped-beam distribution according to the prior art. The brightness inside the light distribution is made clear by isolines which clarify the regions of identical illuminance. In the present illustration, the illuminance assumes a maximum just below the cut-off line and decreases outwards. The course of the cut-off line is clearly discernible in this case. In the left region, in the vicinity of the cut-off line, a downward bulge is discernible, inside which the isolines lie particularly closely next to one another. The measuring point 50L, which is correspondingly darkened, lies inside this region, wherein the darkening in the light image is formed in an inhomogeneous and therefore clearly discernible manner, as can be recognized on the basis of the strong gradients of the illuminance in the region of the measuring point 50L.

FIG. 2 shows a schematic illustration of an exemplary projection device 1 in a microprojection light module 6, wherein the projection device 1 may—as discussed in the following—be equipped with an embodiment of screen devices according to the invention. A projection device 1 according to the invention equipped in such a manner is suitable for use in a motor-vehicle headlamp, wherein the projection device 1 is set up for imaging light of at least one light source 2 assigned to the projection device 1 (preferably however, an individually controllable light source, particularly preferably an LED is assigned to each micro-entrance optical element 3a), in a region in front of a motor vehicle in the form of at least one light distribution, namely a dipped-beam distribution and/or a near-field beam distribution. The light radiated by the light source 2 may for example be deflected onto an entrance optical element 3 by means of a collimator 7. The projection device 1 comprises the entrance optical element 3, which has a total number of micro-entrance optical elements 3a, which are preferably arranged in an array, an exit optical element 4, which has a total number of micro-exit optical elements 4a, which are preferably arranged in an array, wherein exactly one micro-exit optical element 4a is assigned to each micro-entrance optical element 3a.

The micro-entrance optical elements 3a are constructed in such a manner and/or the micro-entrance optical elements 3a and the micro-exit optical elements 4a are arranged in such a manner with respect to one another, that essentially the total light exiting from a micro-entrance optical element 3a only enters into the assigned micro-exit optical element 4a, and wherein the light pre-shaped by the micro-entrance optical elements 3a is imaged by the micro-exit optical elements 4a into a region in front of the motor vehicle as at least one light distribution. Each micro-entrance optical element 3a is constructed in such a manner that the micro-entrance optical element 3a focuses the light passing through it into at least one micro-entrance-optical-element focal point, wherein the micro-entrance-optical-element focal point lies between the micro-entrance optical element 3a and the assigned micro-exit optical element 4a, wherein at least one screen device 8a (cf. FIG. 3) is arranged between the micro-entrance optical element 3a and the micro-exit optical element 4a, wherein a dipped-beam micro-optical element is constructed in each case at least by the micro-entrance optical element 3a, the assigned micro-exit optical element 4a and the at least one screen device 8a lying therebetween.

The at least one screen device 8a is set up for limiting the light distribution imaged by the respective micro-exit optical element 4a in such a manner that the light distribution radiated by the micro-exit optical element 4a forms a portion of the dipped-beam distribution, wherein, for this, the screen device 8a has at least one optically effective screen edge K (see FIGS. 4a, 5a and 6a) imaging the course of a cut-off line of the dipped-beam distribution.

The total number of dipped-beam micro-optical elements comprises at least two groups of dipped-beam micro-optical elements, namely
a first group of dipped-beam micro-optical elements having at least one first variant of screen devices 8a′ (see 4a), and
a second group of dipped-beam micro-optical elements having at least one second variant of screen devices 8a″ (cf. FIG. 6a), wherein the configuration of the second variant of screen devices 8a″ deviates from the configuration of the first variant of screen devices 8a′ at least in that the second variant of screen devices 8a″ has
shading elements A50L protruding along a section of the course of the screen edge (cf. FIG. 5a, incidentally, the shading of the segment A50L may also be at least partially provided by suspended shading elements), and/or
shading elements ASegm10 (cf. FIG. 6a) spaced from the screen edge K, which are completely enclosed by a light-permeable region of the screen device 8a″.

The FIGS. 3 (a) to (d) show a schematic illustration of individual steps of a method for producing a projection device 1 according to the invention for a motor-vehicle headlamp, wherein the projection device 1 is set up for imaging light of at least one light source 2 assigned to the projection device 1 in a region in front of a motor vehicle in the form of at least one light distribution. FIG. 3 (a) shows a support 5 having a first flat side 5a, onto which in FIG. 3 (b) a first screen device 8a is applied, for example by means of screen printing or metal deposition, wherein the support 5 consists at least partially of glass. FIG. 3 (c) shows the next step b) of the method, namely the fastening of an entrance optical element 3, which has a number of micro-entrance optical elements 3a, which are preferably arranged in an array, on the first flat side 5a of the support 5, wherein the entrance optical element 3 at least partially covers the first screen device 8a and is arranged in such a manner that light can enter at least partially into the support 5 via the entrance optical element 3 through the first screen device 8a, and the fastening of the entrance optical element 3 on the first flat side 5a of the support 5 takes place by means of a light-permeable adhesive. FIG. 3 (d) shows the state in which the entrance optical element 3 is already securely connected to the support 5. Subsequently, according to step c), the application of a second screen device—for example to avoid scattered light—can take place on a second flat side 5b of the support 5 opposite the first flat side 5a. Subsequently, the exit optical element 4 can take place on the opposite flat side of the support 5.

FIG. 4a shows an exemplary configuration of screen devices 8a′ lying next to one another according to the prior art and FIG. 4b shows a light distribution generated thereby. It can be discerned therein that the point SOL is not darkened.

FIG. 5a shows a schematic illustration of a configuration according to the invention of screen devices 8a′ and 8a″ lying next to one another, wherein the screen devices 8a″ have shading elements A50L, which are arranged for darkening the region around the measuring point 50L, wherein the shading elements A50L of individual screen devices 8a″ may be configured differently for generating a brightness transition which is as homogeneous as possible. FIG. 5b shows a light distribution, which was generated by means of a projection device 1, comprising screen devices according to FIG. 5a. A comparison with the light distribution according to FIG. 1 makes it particularly clear that although the light distribution according to FIG. 5a likewise achieves a darkening in the measuring point 50L, the transition to the surroundings turns out to be considerably more homogeneous.

FIG. 6a shows a further schematic illustration of a configuration according to the invention of screen devices 8a′ and 8a″ lying next to one another. Individual light-shading elements ASegm10 are provided therein, which are spaced from the screen edge K and which are completely enclosed by a light-permeable region of the screen device 8a″. These shading elements ASegm10 may, in the second variant of the screen devices 8a″, be provided alone or in combination with the shading elements A50L. In the embodiment 6a, screens (not illustrated in the figures) are incidentally likewise also provided, which do not have any shading elements. That is to say there are also screens without shading for segment 10 and 50L. In general, it is true that the number and size and also the geometric shape of the shading elements can be chosen as a function of the desired configuration of the light distribution to be generated.

FIG. 6b shows a light distribution generated by means of a projection device comprising the screen devices according to FIG. 6a. Therein, beyond the shading of the measuring point 50L, an additional darkening in the region of the segment 10 of the light distribution was achieved, wherein a uniform brightness transition was also created here.

Fundamentally, the reduction possibilities can be arranged as desired on the array. It would also be possible to configure the legal points in a variable manner. In the case of the AFS function adverse weather light (Class W) for example, the upper legal limit (e.g. for the segment 10) is lower than in the case of Class C. Precisely the opposite may apply for 50L. In the case of the adverse weather light, this may be considerably higher than in Class C. If one now consciously places only segment 10 lines behind a collimator, the relevant collimator may be added during adverse weather and, in exchange, a collimator without segment 10 lines can be removed in the associated systems. As a result, the total luminous flux is maintained, but the segment 10 line is reduced in the total light distribution. One can proceed in precisely the opposite manner with the 50L measuring point.

Considering this teaching, the person skilled in the art is able, without inventive effort, to arrive at different embodiments of the invention, which are not shown. The invention is therefore not limited to the embodiments shown. Also, individual aspects of the invention or the embodiments may be picked up and combined with one another. What are important are ideas upon which the invention is based, which may be realized by a person skilled in the art, in knowledge of this description, in myriad ways and be maintained as such in spite of that.

1. A projection device (1) for a motor-vehicle headlamp, wherein the projection device (1) is set up for imaging light of at least one light source (2) assigned to the projection device (1) in a region in front of a motor vehicle in the form of at least one light distribution comprising a dipped-beam distribution, wherein the projection device (1) comprises:
an entrance optical element (3), which has a total number of micro-entrance optical elements (3a), which are arranged in an array,
an exit optical element (4), which has a total number of micro-exit optical elements (4a), which are arranged in an array,
wherein exactly one micro-exit optical element (4a) is assigned to each micro-entrance optical element (3a),
wherein the micro-entrance optical elements (3a) are constructed in such a manner and/or the micro-entrance optical elements (3a) and the micro-exit optical elements (4a) are arranged in such a manner with respect to one another, that essentially the total light exiting from a micro-entrance optical element (3a) only enters into the assigned micro-exit optical element (4a),
wherein the light pre-shaped by the micro-entrance optical elements (3a) is imaged by the micro-exit optical elements (4a) into a region in front of the motor vehicle as at least one light distribution,
wherein each micro-entrance optical element (3a) focuses the light passing through it into at least one micro-entrance-optical-element focal point, wherein the micro-entrance-optical-element focal point lies between the micro-entrance optical element (3a) and the assigned micro-exit optical element (4a), wherein at least one screen device (8a′, 8a″) is arranged between the micro-entrance optical element (3a) and the micro-exit optical element (4a),
wherein, in each case, a dipped-beam micro-optical element is constructed at least by the micro-entrance optical element (3a), the assigned micro-exit optical element (4a) and also the at least one screen device (8a′, 8a″) lying therebetween,
wherein the at least one screen device (8a′, 8a″) is set up for limiting the light distribution imaged by the respective micro-exit optical element (4a) in such a manner that the light distribution radiated by the micro-exit optical element (4a) forms a portion of the dipped-beam distribution, wherein, for this, the screen device (8a′, 8a″) has at least one optically effective screen edge (K) imaging the course of a cut-off line of the dipped-beam distribution,
wherein the total number of dipped-beam micro-optical elements comprises at least two groups of dipped-beam micro-optical elements, comprising:
a first group of dipped-beam micro-optical elements having at least one first variant of screen devices (8a′), and
a second group of dipped-beam micro-optical elements having at least one second variant of screen devices (8a″), wherein the configuration of the second variant of screen devices (8a″) deviates from the configuration of the first variant of screen devices (8a′) at least in that the second variant of screen devices (8a″) comprises:
shading elements (A50L) protruding along a section of the course of the screen edge (K), and/or
shading elements (ASegm10) spaced from the screen edge (K), which are completely enclosed by a light-permeable region of the screen device (8a″).

2. The projection device (1) according to claim 1, wherein each dipped-beam micro-optical element, which has a screen device (8a″) of the second variant, has exactly one shading element (A50L) protruding along a section of the course of the screen edge (K).

3. The projection device (1) according to claim 1, wherein each dipped-beam micro-optical element, which has a screen device (8a″) of the second variant, has exactly one shading element (Asegm10) spaced from the screen edge (K), which is completely enclosed by a light-permeable region of the screen device (8a″).

4. The projection device (1) according to claim 1, wherein the at least one screen device (8a′, 8a″) is connected to a light-permeable support (5), which is coated on its surface with an at least partially non-light-permeable material to form a predeterminable light distribution.

5. The projection device (1) according to claim 1, wherein at least individual shading elements (A50L, ASegm10) of the screen device (8a″) of the second variant are partially light-permeable.

6. The projection device (1) according to claim 1, wherein at least individual shading elements (A50L, ASegm10) of the screen device (8a″) of the second variant are completely non-light-permeable.

7. The projection device (1) according to claim 1, wherein individual shading elements (A50L) of the screen device (8a″) of the second variant are provided for limiting the luminosity of the light distribution in a 50L measuring point.

8. The projection device (1) according to claim 7, wherein the individual shading elements (A50L) are arranged in such a manner that they shade a region of the light distribution radiated by the respective dipped-beam micro-optical element, wherein the region comprises a horizontal angle of at most 5° and a vertical angle of at most 5°.

9. The projection device (1) according to claim 1, wherein the size of at least one shading element (A50L, ASegm10) of a screen device (8a″) of the second variant deviates from the size of at least one shading element (A50L, ASegm10) of a further screen device (8a″) of the second variant.

10. The projection device (1) according to claim 1, wherein individual shading elements (A50L, ASegm10) of the screen device (8a″) of the second variant are provided for limiting the luminosity of the light distribution in segment 10 of the dipped-beam distribution.

11. The projection device (1) according to claim 10, wherein the individual shading elements (A50L, ASegm10) are arranged in such a manner that they shade a region of the light distribution radiated by the respective dipped-beam micro-optical element, wherein the region comprises a horizontal angle of at most 10° and a vertical angle of at most 3°.

12. The projection device (1) according to claim 1, wherein the support (5) of the at least one screen device (8a′, 8a″) comprises glass, wherein the entrance optical element (3) and also the exit optical element (4) are securely connected to at least one support (5) of the screen device (8a′, 8a″) arranged between the entrance optical element (3) and the exit optical element (4), wherein the secure connection of the entrance optical element (3) and the exit optical element (4) to the at least one support (5) is constructed as a transparent adhesively-bonded connection in each case.

13. The projection device (1) according to claim 1, wherein the total number of dipped-beam micro-optical elements comprises a third group of dipped-beam micro-optical elements with screen devices of a third variant, in that, in the screen device of the third variant
at least one at least partially light-permeable window is formed, inside a light-shading region of the screen device constructed up to the screen edge (K), for forming a light distribution lying above the cut-off line.

14. A microprojection light module (6) for a motor-vehicle headlamp, comprising at least one projection device (1) according to claim 1 and at least one light source (2) for feeding light into the projection device (1).

15. A vehicle headlamp, motor-vehicle headlamp comprising at least one microprojection light module (6) according to claim 14.
